(19) United States
(12) Patent Application Publication
(10) Pub. No.: US 2026/0104287 A1
(43) Pub. Date: Apr. 16, 2026

(54) INFORMATION PROCESSING METHOD, INFORMATION PROCESSING DEVICE, AND RECORDING MEDIUM

(71) Applicant: Panasonic Intellectual Property Management Co., Ltd., Osaka (JP)

(72) Inventors: Madoka Wada, Osaka (JP); Takahiro Kamai, Kyoto (JP); Katsunori Daimo, Osaka (JP)

(21) Appl. No.: 19/381,085

(22) Filed: Nov. 6, 2025

Related U.S. Application Data
(63) Continuation of application No. PCT/JP2024/016760, filed on May 1, 2024.

(30) Foreign Application Priority Data
May 18, 2023 (JP) 2023-082203

(51) Int. Cl. G01H 17/00

(52) U.S. Cl. CPC G01H 17/00

(57) ABSTRACT

An information processing method is executed by a computer and includes: acquiring sound data obtained by picking up a sound emitted from a target object; when the sound data contains a non-steady sound, presenting a waveform of the non-steady sound; acquiring an input of a target range to be extracted in the waveform of the non-steady sound presented; and extracting, from the sound data, one or more similar ranges that each contain a waveform similar to a waveform of the target range acquired.

### CROSS REFERENCE TO RELATED APPLICATIONS

This is a continuation application of PCT International Application No. PCT/JP2024/016760 filed on May 1, 2024, designating the United States of America, which is based on and claims priority of Japanese Patent Application No. 2023-082203 filed on May 18, 2023. The entire disclosures of the above-specified applications, including the specifications, drawings and claims are incorporated herein by reference in their entirety.

### FIELD

The present disclosure relates to an information processing method, an information processing device, and a recording medium.

### BACKGROUND

Patent Literature (PTL) 1 discloses a sound evaluation device that can separately evaluate a steady sound and a non-steady sound separated from a plurality of sound sources generated from a device.

### CITATION LIST

### Patent Literature

### PTL 1: Japanese Unexamined Patent Application Publication No. 2009-236645

### SUMMARY

### Technical Problem

Non-steady sound can include noise, ambient environmental sounds, and the like in addition to a sound emitted from a target object such as a device. There may be cases where when the non-steady sound is used to analyze the target object, the analysis accuracy is low. Accordingly, there is a demand for extracting a target sound from the non-steady sound. However, extracting the target sound requires an enormous effort.

In view of the above, the present disclosure provides an information processing method, an information processing device, and a recording medium, with which it is possible to assist in extraction of a target sound from a non-steady sound.

### Solution to Problem

An information processing method according to one aspect of the present disclosure is an information processing method executed by a computer including: acquiring sound data obtained by picking up a sound emitted from a target object; when the sound data contains a non-steady sound, presenting a waveform of the non-steady sound; acquiring an input of a first target range in the waveform of the non-steady sound presented, the first target range being a target range to be extracted; and extracting, from the sound data, one or more first similar ranges that each contain a waveform similar to a waveform of the first target range acquired.

An information processing device according to one aspect of the present disclosure includes: a first acquirer that acquires sound data obtained by picking up a sound emitted from a target object; a presentation controller that, when the sound data contains a non-steady sound, presents a waveform of the non-steady sound; a second acquirer that acquires an input of a first target range in the waveform of the non-steady sound presented, the first target range being a target range to be extracted; and an extractor that extracts, from the sound data, one or more first similar ranges that each contain a waveform similar to a waveform of the first target range acquired.

A recording medium according to one aspect of the present disclosure is a non-transitory computer-readable recording medium having recorded thereon a program for causing a computer to execute the information processing method described above.

### ADVANTAGEOUS EFFECTS

According to one aspect of the present disclosure, it is possible to achieve an information processing method and the like, with which it is possible to assist in extraction of a target sound from a non-steady sound.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing a functional configuration of an information processing system according to an embodiment.

FIG. 2 is a diagram showing one example of a waveform of a steady sound.

FIG. 3 is a diagram showing one example of a waveform of a non-steady sound.

FIG. 4 is a flowchart illustrating a sound registration operation performed by the information processing system according to the embodiment.

FIG. 5A is a diagram showing sound data of picked up sound.

FIG. 5B is a diagram showing a first target range input for the sound data of picked up sound.

FIG. 5C is a diagram showing one or more first similar ranges automatically extracted for a waveform of the first target range.

FIG. 5D is a diagram showing a second target range input for the sound data of picked up sound.

FIG. 5E is a diagram showing one or more second similar ranges automatically extracted for a waveform of the second target range.

FIG. 6 is a flowchart illustrating a learning operation performed by the information processing system according to the embodiment.

FIG. 7 is a diagram illustrating a method for evaluating a generated machine learning model according to the embodiment.

FIG. 8 is a flowchart illustrating a sound registration operation performed by an information processing system according to Variation 1 of the embodiment.

FIG. 9 is a flowchart illustrating a sound registration operation performed by an information processing system according to Variation 2 of the embodiment.

FIG. 10 is a flowchart illustrating a sound registration operation performed by an information processing system according to Variation 3 of the embodiment.

FIG. 11A is a diagram showing possible registration candidate ranges automatically extracted for the sound data of picked up sound.

FIG. 11B is a diagram showing the possible registration candidate ranges that are left after one of the possible registration candidate ranges has been deleted by a user.

### DESCRIPTION OF EMBODIMENTS

An information processing method according to a first aspect of the present disclosure is an information processing method executed by a computer including: acquiring sound data obtained by picking up a sound emitted from a target object; when the sound data contains a non-steady sound, presenting a waveform of the non-steady sound; acquiring an input of a first target range in the waveform of the non-steady sound presented, the first target range being a target range to be extracted; and extracting, from the sound data, one or more first similar ranges that each contain a waveform similar to a waveform of the first target range acquired.

With this configuration, by a user simply inputting a target sound (a sound of interest) for the sound data, it is possible to automatically extract a sound similar to the target sound from the sound data that contains the acquired non-steady sound. That is, the user does not have to input the sound similar to the target sound, and it is therefore possible to reduce the effort of the user required to extract the sound from the non-steady sound. Accordingly, it is possible to implement the information processing method that can assist in extraction of the target sound from the non-steady sound.

Also, for example, an information processing method according to a second aspect is the information processing method according to the first aspect that may further include: after the extracting of the one or more first similar ranges, acquiring an input of a second target range in the waveform of the non-steady sound presented, the second target range being another target range to be extracted; and extracting, from the sound data, one or more second similar ranges that each contain a waveform similar to a waveform of the second target range acquired.

With this configuration, by the user additionally inputting a target sound (a sound of interest) for the sound data, it is possible to automatically extract a sound similar to the added target sound from the sound data that contains the acquired non-steady sound.

Also, for example, an information processing method according to a third aspect is the information processing method according to the first or second aspect that may further include: when a variation in the one or more first similar ranges based on a first similarity level between the waveform of the first target range and a waveform of each of the one or more first similar ranges is less than a first threshold value, specifying a second target range whose similarity level with respect to the waveform of the first target range is different from the first similarity level; and extracting, from the sound data, one or more second similar ranges that each contain a waveform similar to a waveform of the second target range specified.

With this configuration, when the variation in the extracted one or more first similar ranges is small, one or more second similar ranges are extracted to increase the variation, and thus various target sounds can be automatically extracted. Accordingly, it is possible to implement the information processing method that can further assist in extraction of the target sound from the non-steady sound.

Also, for example, an information processing method according to a fourth aspect is the information processing method according to any one of the first to third aspects, wherein the one or more first similar ranges may be a range which includes a waveform that has a similarity level greater than or equal to a third threshold value with respect to the waveform of the first target range, and when a variation in the one or more first similar ranges based on a first similarity level between the waveform of the first target range and a waveform of each of the one or more first similar ranges is greater than a second threshold value, the third threshold value may be changed to a fourth threshold value that is greater than the third threshold value, and the one or more first similar ranges may be re-extracted based on the fourth threshold value changed from the third threshold value.

When the variation is large, there may be a possibility that the extracted one or more first similar ranges include a sound other than the sound emitted from the target object. When the variation is large, by changing the threshold value for similarity level (for example, by changing the threshold value to a greater value), a first similar range that contains a sound other than the sound emitted from the target object can be automatically removed. Accordingly, it is possible to implement the information processing method that can further assist in extraction of the target sound from the non-steady sound.

Also, for example, an information processing method according to a fifth aspect is the information processing method according to any one of the first to fourth aspects that may include: when a total number of the one or more first similar ranges extracted is less than a fifth threshold value, specifying a second target range that is different from the first target range and the one or more first similar ranges; and extracting, from the sound data, one or more second similar ranges that each contain a waveform similar to a waveform of the second target range specified.

With this configuration, when the number of extracted first similar ranges is small, one or more second similar ranges can be additionally automatically extracted. Accordingly, it is possible to implement the information processing method that can further assist in extraction of the target sound from the non-steady sound.

Also, for example, an information processing method according to a sixth aspect is the information processing method according to any one of the first to fifth aspects, wherein the one or more first similar ranges may be a range which includes a waveform that has a similarity level greater than or equal to a third threshold value with respect to the waveform of the first target range, and when a total number of the one or more first similar ranges extracted is greater than a sixth threshold value, the third threshold value may be changed to a fourth threshold value that is greater than the third threshold value, and the one or more first similar ranges may be re-extracted based on the fourth threshold value changed from the third threshold value.

With this configuration, when there are a large number of extracted first similar ranges, by changing the threshold value for similarity level (for example, by changing the threshold value to a greater value), the number of extracted first similar ranges can be automatically reduced. Accordingly, it is possible to implement the information processing method that can further assist in extraction of the target sound from the non-steady sound.

Also, for example, an information processing method according to a seventh aspect is the information processing method according to any one of the second aspect, the third aspect, or the fifth aspect that may further include: presenting the one or more first similar ranges extracted, and after the presenting of the one or more first similar ranges extracted, acquiring the input of the second target range.

With this configuration, the user can determine whether it is necessary to additionally set the second target range after the user checked the first similar ranges. That is, it is possible to assist the user in determining whether it is necessary to additionally set the second target range. Accordingly, it is possible to implement the information processing method that can further assist in extraction of the target sound from the non-steady sound.

Also, for example, an information processing method according to an eighth aspect is the information processing method according to any one of the second aspect, the third aspect, the fifth aspect, or the seventh aspect that may further include: presenting the one or more second similar ranges extracted.

With this configuration, it is possible to cause the user to check the sound obtained by combining the waveforms of the extracted second similar ranges. The user can make various decisions based on the sound of the second similar ranges. Accordingly, it is possible to implement the information processing method that can further assist in extraction of the target sound from the non-steady sound.

Also, for example, an information processing method according to a ninth aspect is the information processing method according to any one of the first to eighth aspects that may further include: displaying a waveform of the sound data and reproducing the sound data; and after the displaying of the waveform of the sound data and the reproducing of the sound data, acquiring the input of the first target range.

With this configuration, it is possible to cause the user to make a decision at an early stage as to whether the acquired non-steady sound can be used for sound registration. Accordingly, it is possible to suppress a situation in which processing such as extraction processing is executed on the non-steady sound that cannot be used for sound registration. This reduces the amount of processing required by the information processing device that executes the information processing method.

Also, for example, an information processing method according to a tenth aspect is the information processing method according to any one of the first to ninth aspects that may further include: combining together the waveform of the first target range and the waveform of each of the one or more first similar ranges; and reproducing sound data that includes a waveform obtained as a result of the combining.

With this configuration, it is possible to cause the user to check the sound obtained by combining the waveforms of the first target range and the one or more first similar ranges. The user can make various decisions based on the sound of the first similar ranges. Accordingly, it is possible to implement the information processing method that can further assist in extraction of the target sound from the non-steady sound.

Also, for example, an information processing method according to an eleventh aspect is the information processing method according to any one of the second aspect, the third aspect, the fifth aspect, the seventh aspect, or the eighth aspect that may further include: combining together the waveform of the first target range, the waveform of the second target range, the waveform of each of the one or more first similar ranges, and the waveform of each of the one or more second similar ranges; and reproducing sound data that includes a waveform obtained as a result of the combining.

With this configuration, it is possible to cause the user to check the sound obtained by combining the waveforms of the first target range, the second target range, the one or more first similar ranges, and the one or more second similar ranges. This reduces the amount of processing required by the information processing device that executes the information processing method as compared with the case where the sounds of the waveforms of the first target range, the second target range, the one or more first similar ranges, and the one or more second similar ranges are reproduced separately without combining the waveforms.

Also, for example, an information processing method according to a twelfth aspect is the information processing method according to any one of the first to eleventh aspects, wherein the target object may be a production device, and the sound emitted from the target object may include a sound picked up during operation of the production device.

With this configuration, it is possible to implement the information processing method that can assist in extraction of the target sound from the non-steady sound emitted from the production device.

Also, an information processing device according to a thirteenth aspect of the present disclosure includes: a first acquirer that acquires sound data obtained by picking up a sound emitted from a target object; a presentation controller that, when the sound data contains a non-steady sound, presents a waveform of the non-steady sound; a second acquirer that acquires an input of a first target range in the waveform of the non-steady sound presented, the first target range being a target range to be extracted; and an extractor that extracts, from the sound data, one or more first similar ranges that each contain a waveform similar to a waveform of the first target range acquired. Also, a recording medium according to a fourteenth aspect of the present disclosure is a non-transitory computer-readable recording medium having recorded thereon a program for causing a computer to execute the information processing method according to any one of the first to twelfth aspects.

With the configurations described above, the same advantageous effects as those of the information processing method described above can be obtained.

These general and specific aspects may be implemented using a system, a method, an integrated circuit, a computer program, or a computer-readable non-transitory recording medium such as a CD-ROM, or any combination of systems, methods, integrated circuits, computer programs, or computer-readable recording media. The program may be stored in advance in a recording medium, or supplied to a recording medium via a wide area communication network such as the Internet.

Hereinafter, an embodiment will be described specifically with reference to the drawings.

Each of the exemplary embodiment and the like described below shows a general or specific example. The numerical values, shapes, structural elements, the arrangement and connection of the structural elements, steps, the processing order of the steps etc. shown in the following exemplary embodiment and the like are merely examples, and therefore do not limit the scope of the present disclosure. Also, among the structural elements in the following exemplary embodiment and the like, those not recited in any one of the independent claims are described as optional structural elements.

Also, the diagrams are schematic representations, and thus are not necessarily true to scale. Accordingly, for example, the dimensions and the like in the diagrams do not necessarily match. Also, in the diagrams, structural elements that are substantially the same are given the same reference numerals, and a redundant description is omitted or simplified.

Also, in the specification of the present application, the terms that describe the relationship between elements such as “same”, numerical values, and numerical value ranges are expressions that not only have a strict meaning but also encompass a substantially equal range, for example, a margin of about several percent (or about 10%).

Also, in the specification of the present application, unless otherwise stated, the ordinal numbers such as “first” and “second” do not mean the number or order of structural elements, and are used to avoid confusion of the same type of structural elements and make a distinction between the same type of structural elements.

### Embodiment

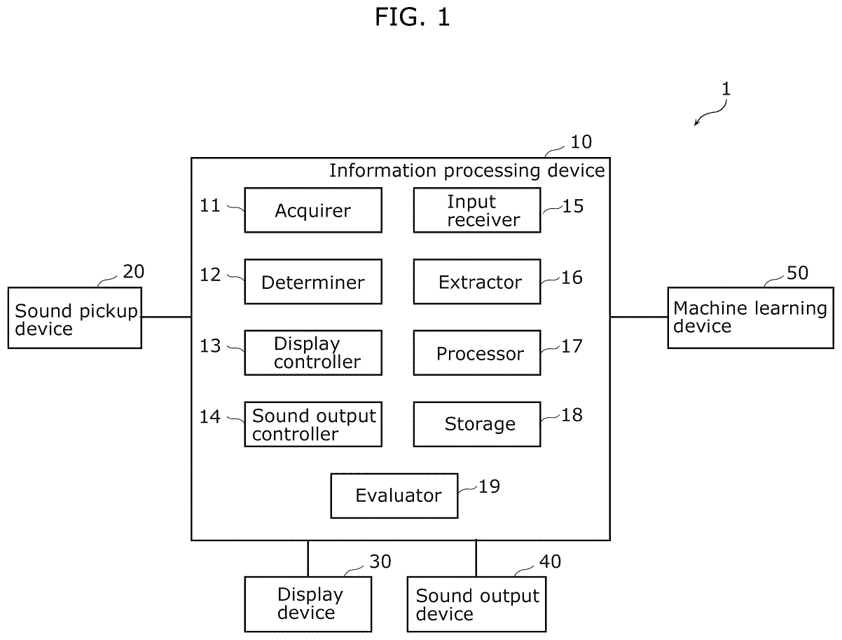

Hereinafter, an information processing system according to the present embodiment will be described with reference to FIGS. 1 to 7.

### 1. Configuration of Information Processing System

First, a configuration of the information processing system according to the present embodiment will be described with reference to FIGS. 1 to 3. FIG. 1 is a block diagram showing a functional configuration of information processing system 1 according to the present embodiment.

As shown in FIG. 1, information processing system 1 is an assistance system for assisting in registration of sound data for training a machine learning model, and includes information processing device 10, sound pickup device 20, and display device 30. Information processing system 1 may further include machine learning device 50. Information processing device 10 is connected to each of sound pickup device 20, display device 30, sound output device 40, and machine learning device 50 to be capable of performing communication with these devices.

The machine learning model receives, as an input, sound data obtained by picking up a sound emitted from a target object, and outputs information that indicates the timing at which the target sound was emitted. The target object is a device that emits sound during operation of the device, and may be, for example, a production device that processes workpieces, or the like. However, the target object is not limited thereto. Hereinafter, an example will be described in which the target object is the production device. Also, the term “to register sound data” means to store the sound data as input data used to train the machine learning model.

Information processing device 10 includes acquirer 11, determiner 12, display controller 13, sound output controller 14, input receiver 15, extractor 16, processor 17, storage 18, and evaluator 19. Information processing device 10 includes a central processing unit (CPU), a memory, and the like, and each function of information processing device 10 is implemented by the CPU executing a program stored in the memory. Information processing device 10 may be implemented using, for example, a computer or a server.

Acquirer 11 acquires, from sound pickup device 20 that picks up a sound emitted from the production device, sound data obtained by sound pickup device 20 picking up the sound. The production device includes a plurality of driving mechanisms, and emits sounds generated as a result of the plurality of driving mechanisms operating or coming into contact. Acquirer 11 acquires sound data of the sound picked up during operation of the production device. The sound data is waveform data (for example, digital data) obtained by sampling the sound emitted from the production device. Acquirer 11 includes, for example, a communication circuit (a communication module). Acquirer 11 is one example of a first acquirer.

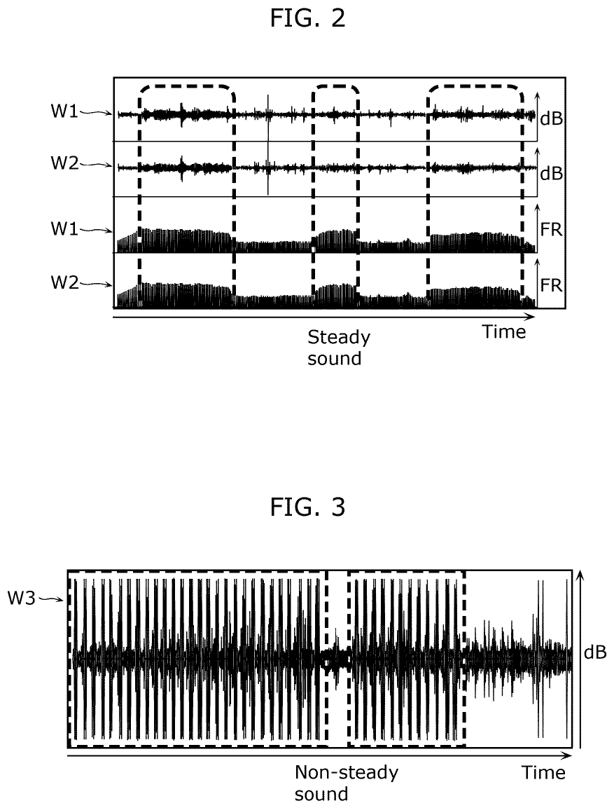

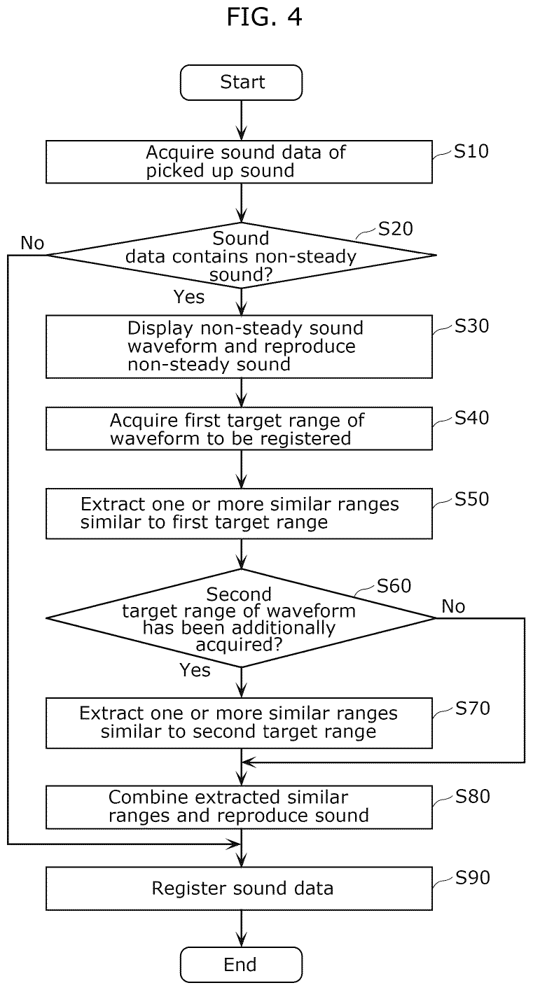

The sound contained in the sound data acquired by acquirer 11 can be roughly divided into a steady sound and a non-steady sound. The steady sound and the non-steady sound will be described with reference to FIGS. 2 and 3.

FIG. 2 is a diagram showing one example of a waveform (sound waveform) of a steady sound. FIG. 2 shows a graph showing the sound intensity of sound data W1 and sound data W2 (sound data W1 and W2 shown in the upper part) and a graph showing the frequency spectrogram of sound data W1 and sound data W2 (sound data W1 and W2 shown in the lower part) that are arranged in the up-down direction. Sound data W1 and sound data W2 are sound data obtained by picking up the steady sound. Also, in the graph of sound data W1 and sound data W2 shown in the upper part of FIG. 2, the horizontal axis indicates time, and the vertical axis indicates sound intensity (dB). Likewise, in the graph of sound data W1 and W2 shown in the lower part of FIG. 2, the horizontal axis indicates time, and the vertical axis indicates frequency (Hz).

As shown in FIG. 2, the steady sound contains a sound produced continuously for a predetermined length of time (for example, for several seconds). For example, the steady sound is a sound produced steadily for a certain period of time during operation of the production device. In the case where the production device includes a motor, operating noise produced by the motor and the like are included in the steady sound.

Dashed frames shown in FIG. 2 indicate ranges in which a sound of interest is extracted from the sound data. These ranges can be easily (for example, automatically) specified because the steady sound is produced continuously for the predetermined length of time. As used herein, the term “sound of interest” refers to, for example, a sound emitted from the production device, and corresponds to one example of a target sound to be extracted. Also, the sound of interest is used to, for example, train the machine learning model.

FIG. 3 is a diagram showing one example of a waveform (sound waveform) of a non-steady sound. FIG. 3 shows a graph showing the sound intensity of sound data W3. Sound data W3 is data obtained by picking up the non-steady sound. In FIG. 3, the horizontal axis indicates time, and the vertical axis indicates sound intensity (dB).

As shown in FIG. 3, the non-steady sound contains a plurality of sounds (for example, instantaneous sounds) that are shorter than the predetermined length of time. The non-steady sound is a sound produced locally during operation of the production device, and may be, for example, an impact sound, a friction sound, or the like. A sound generated by a collision between workpieces to be processed or the like, a sound generated by the workpieces coming into contact with a driving mechanism or the like, and the like are also included in the non-steady sound.

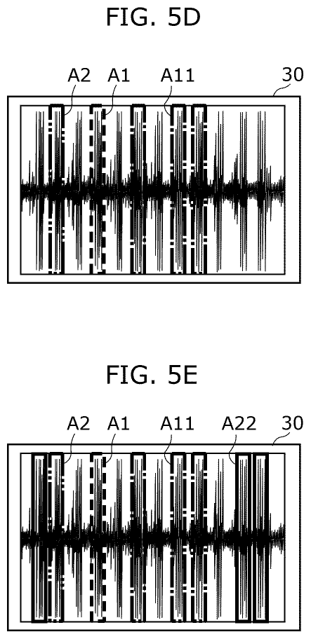

The non-steady sound contains, for example, a plurality of alternating high-amplitude first portions W3a (see FIG. 5A, which will be described later) and low-amplitude second portions W3b (see FIG. 5A, which will be described later). First portions W3a each indicate a sound picked up while the production device was emitting sounds. Second portions W3b each indicate a sound picked up while the production device was not emitting sounds, and may be, for example, noise, ambient environmental sounds, and the like. If, for example, portions indicated by dashed frames in FIG. 3 are extracted and used to train the machine learning model, because the portions indicated by the dashed frames contain sounds picked up while the production device was not emitting sounds, there is a possibility that the accuracy of the machine learning model to be generated may be reduced. To address this, it is desirable to extract, from the non-steady sound, portions used by machine learning device 50 to perform training (the portions corresponding to the sound of interest such as, for example, first portions W3a), but the extraction is not easy to perform. Accordingly, as will be described below, information processing device 10 executes assistance processing for easily extracting the sound of interest from the non-steady sound.

Acquirer 11 acquires, for example, sound data of picked-up steady sound as shown in FIG. 2 or sound data of picked-up non-steady sound as shown in FIG. 3.

Referring again to FIG. 1, determiner 12 determines whether the sound data acquired by acquirer 11 contains a non-steady sound. If it is determined that the sound data acquired by acquirer 11 contains, for example, a portion in which a duration during which an amplitude greater than or equal to a predetermined value continues is greater than or equal to a first duration, determiner 12 determines that the sound data contains a steady sound. If it is determined that the sound data contains a portion in which the duration during which the amplitude greater than or equal to the predetermined value continues is less than a second duration, determiner 12 determines that the sound data contains a non-steady sound. The first duration and the second duration may have the same length of time, or, for example, the second duration may be shorter than the first duration.

Display controller 13 performs control regarding images to be displayed by display device 30. Display controller 13 causes display device 30 to display information regarding the sound data acquired by acquirer 11. For example, in the case where the sound data acquired by acquirer 11 contains a non-steady sound, display controller 13 causes display device 30 to display a waveform of the non-steady sound. Display controller 13 causes display device 30 to display the non-steady sound by, for example, generating a control signal for displaying the non-steady sound contained in the sound data acquired by acquirer 11, and outputting the generated control signal to display device 30. Displaying the non-steady sound is one example of presenting the non-steady sound. Display controller 13 is one example of a presentation controller.

Sound output controller 14 performs control regarding sounds to be output (reproduced) by sound output device 40. Sound output controller 14 causes sound output device 40 to output a sound regarding the sound data acquired by acquirer 11. For example, in the case where the sound data acquired by acquirer 11 contains a non-steady sound, sound output controller 14 causes sound output device 40 to output the non-steady sound. Sound output controller 14 causes sound output device 40 to output the non-steady sound by, for example, generating a control signal for outputting the non-steady sound contained in the sound data acquired by acquirer 11 and outputting the generated control signal to sound output device 40. Outputting the non-steady sound is one example of presenting the non-steady sound. Sound output controller 14 is one example of a presentation controller.

Input receiver 15 is a user interface that receives an input from the user. Input receiver 15 receives an input of a sound range in the non-steady sound that needs to be extracted (for example, a range (first target range A1) indicated by a dashed frame shown in FIG. 5B, which will be described later). Input receiver 15 receives, for example, an input of a target range (see, for example, first target range A1 or the like) that is an extraction target portion in the waveform of the non-steady sound displayed by display device 30. Input receiver 15 is implemented using a touch panel, a button, a keyboard, or the like, but may be configured to receive an input using voice, a gesture, or the like. Input receiver 15 is one example of a second acquirer.

Extractor 16 extracts, in the waveform of the non-steady sound, one or more similar ranges (see, for example, first similar ranges A11 or the like shown in FIG. 5C, which will be described later) that each include a waveform that is similar to the waveform of the target range that was input via input receiver 15. Extractor 16 executes, for example, processing of specifying one or more similar ranges to be displayed for the user, and does not necessarily need to execute processing of extracting the specified one or more similar ranges.

Processor 17 executes predetermined processing on the target range and the one or more similar ranges. Processor 17 combines the target range and the one or more similar ranges together. Processor 17 may extract the target range and the one or more similar ranges from the sound data, and combine them together. As used herein, the term “to combine” means to connect the waveforms of the target range and the one or more similar ranges in terms of time to generate one continuous waveform.

Storage 18 stores the sound data generated by processor 17 as machine learning model training data. Storage 18 is implemented using a semiconductor memory, a hard disk, or the like.

Evaluator 19 evaluates the machine learning model trained by machine learning device 50 using the training data generated by information processing device 10. Evaluator 19 evaluates the rate of accuracy of an output from the machine learning model and the like based on an output obtained by inputting the sound data (raw data) that contains a non-steady sound acquired by acquirer 11 into the machine learning model, and the target range and the similar ranges in the non-steady sound.

The functions of evaluator 19 do not necessarily need to be included in information processing device 10, and may be included in, for example, machine learning device 50.

Sound pickup device 20 is provided at a position near the production device, and picks up sounds from the production device. The sounds picked up by sound pickup device 20 include sounds picked up during operation of the production device. Sound pickup device 20 is implemented using, for example, a microphone or the like.

Display device 30 displays various types of information for the user according to the control of display controller 13. Display device 30 is implemented using, for example, a liquid crystal display device or the like. Display device 30 may be integrated with information processing device 10 into a unitary device.

Sound output device 40 outputs various types of sounds for the user according to the control of sound output controller 14. Sound output device 40 outputs the sound data acquired by acquirer 11 and the training data generated by processor 17. Sound output device 40 is implemented using, for example, a loudspeaker or the like. Sound output device 40 may be integrated with display device 30 into a unitary device.

Machine learning device 50 receives sound data as input data and trains the machine learning model that outputs information that indicates sounds emitted by the production device in the sound data. As the input data, sound data (training data) registered by information processing device 10 is used, and positions on waveform of the target region and the one or more similar regions in the sound data are used as correct data.

As the machine learning model algorithm, for example, a neural network can be used. However, there is no particular limitation on the type of neural network. In the case where a neural network is used as the machine learning model, machine learning device 50 generates the machine learning model by updating network parameters (for example, weight and bias) of the machine learning model using the sound data registered by information processing device 10.

### 2. Operation of Information Processing System

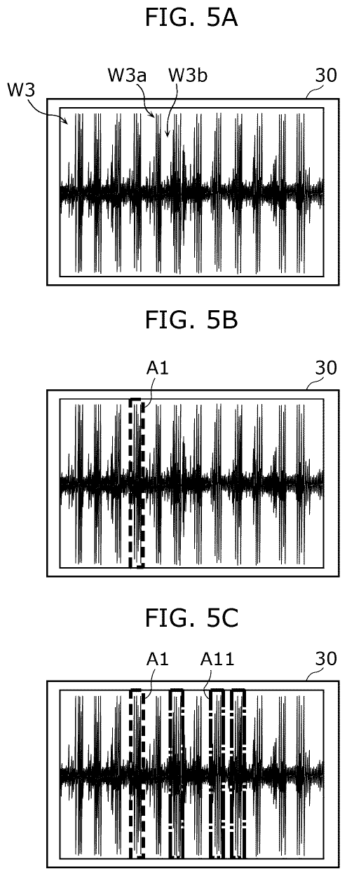

Next, an operation performed by information processing system 1 configured as described above will be described with reference to FIGS. 4 to 7. FIG. 4 is a flowchart illustrating a sound registration operation (an information processing method) performed by information processing system 1 according to the present embodiment. FIG. 4 shows an operation executed by information processing device 10 (for example, a computer).

As shown in FIG. 4, acquirer 11 acquires sound data of picked up sound from sound pickup device 20 (S10). There is no particular limitation on a timing at which acquirer 11 acquires the sound data. Acquirer 11 outputs the acquired sound data to determiner 12.

Next, determiner 12 determines whether the sound data acquired from acquirer 11 contains a non-steady sound (S20).

Next, if it is determined by determiner 12 that the sound data contains a non-steady sound (Yes in S20), display controller 13 controls display device 30 to display a waveform of the non-steady sound. Sound output controller 14 controls sound output device 40 to reproduce (output) the non-steady sound (S30). For example, display controller 13 causes display device 30 to display the waveform of the non-steady sound by generating a control signal that contains the waveform of the non-steady sound and outputting the generated control signal to display device 30. Also, for example, sound output controller 14 causes sound output device 40 to reproduce the non-steady sound by generating a control signal that contains the waveform of the non-steady sound and outputting the generated control signal to sound output device 40.

In step S30, it is sufficient that at least one of the displaying of the non-steady sound or the reproducing of the non-steady sound is executed. The displaying of the non-steady sound or the reproducing of the non-steady sound is one example of presenting the waveform of the non-steady sound. Also, if Yes is determined in step S20, determiner 12 may store sound data W3 (see, for example, FIG. 5A, which will be described later) acquired from sound pickup device 20 in storage 18 so as to use sound data W3 as evaluation data. The evaluation data stored in storage 18 is, for example, sound data that has not been subjected to editing such as extraction performed by extractor 16.

FIG. 5A is a diagram showing sound data of picked up sound.

As shown in FIG. 5A, display controller 13 causes display device 30 to display the waveform of the non-steady sound. The waveform of the non-steady sound displayed in step S30 may be raw data that has not been processed from the sound data acquired by acquirer 11. A configuration is also possible in which, after display controller 13 caused display device 30 to display the waveform shown in FIG. 5A, input receiver 15 receives a decision from the user as to whether to register the waveform. In the case where the user makes a decision as to whether to register the waveform, in step S30, it is sufficient that at least one of the displaying of the non-steady sound or the reproducing of the non-steady sound is executed.

Referring again to FIG. 4, next, input receiver 15 acquires first target range A1 (see FIG. 5B, which will be described later) of the waveform to be registered out of the non-steady sound (S40). It can also be said that input receiver 15 acquires, for example, an input of first target range A1 that is an extraction target portion in the displayed waveform (raw data) from the user. Input receiver 15 may receive, for example, an input of a portion (range) corresponding to first target range A1 from the waveform shown in FIG. 5A, or may display a plurality of possible candidate ranges for first target range A1, and receive a selection of one or more first target ranges A1 from among the plurality of possible candidate ranges. First target range A1 is a range, in the sound data shown in FIG. 5A, that includes a waveform that can be used as a machine learning model training sound.

FIG. 5B is a diagram showing first target range A1 input for the sound data of picked up sound.

As shown in FIG. 5B, input receiver 15 receives, for example, an input of first target range A1. First target range A1 is, for example, a range that contains any one of first portions W3a.

The image shown in FIG. 5B may be displayed on display device 30 under control of controller 13. Also, the sound of first target range A1 shown in FIG. 5B may be output from sound output device 40 under control of sound output controller 14.

Input receiver 15 outputs received first target range A1 to extractor 16.

Referring again to FIG. 4, extractor 16 extracts, based on acquired first target range A1, one or more first similar ranges A11 that are similar to first target range A1 from the waveform shown in FIG. 5A (S50). Any existing technique can be used to extract first similar range A11. Extractor 16 may extract, as one or more first similar ranges A11, one or more ranges that contain a waveform whose shape is similar to the waveform of first target range A1. Also, extractor 16 may extract, as one or more first similar ranges A11, one or more ranges that contain a waveform whose frequency region is similar to (for example, at least partially overlaps) that of the waveform of first target range A1 based on the lower graph showing the frequency spectrogram in FIG. 2 or the like. Also, extractor 16 may extract, as one or more first similar ranges A11, one or more ranges with a similar feature quantity based on the waveform of first target range A1.

Extractor 16 may extract, as the one or more first similar ranges, for example, one or more ranges whose similarity level with respect to the waveform of first target range A1 satisfies a threshold value (a third threshold value). Extractor 16 may extract, as the one or more first similar ranges, for example, one or more ranges whose similarity level with respect to the waveform of first target range A1 is greater than or equal to the threshold value. As used herein, the expression “similarity level satisfies a threshold value” may mean that: for example, the correlation coefficient between two waveforms is greater than or equal to the threshold value; for example, the frequency region of the waveform of first target range A1 overlaps a frequency region that is greater than or equal to the threshold value; or, for example, the distance in a two-dimensional space that indicates a two-dimensional feature quantity into which the waveform of first target range A1 is converted is less than the threshold value.

As described above, extractor 16 may automatically extract one or more first similar ranges A11 using the similarity level with respect to the waveform of first target range A1. The method used by extractor 16 to automatically extract one or more first similar ranges A11 is not limited thereto, and any existing technique can be used.

FIG. 5C is a diagram showing one or more first similar ranges A11 automatically extracted for the waveform of first target range A1. In FIG. 5C, first similar ranges A11 are indicated by a dash-dotted line.

FIG. 5C shows an example in which three first similar ranges A11 have been automatically extracted for first target range A1. The image shown in FIG. 5C may be displayed on display device 30 under control of controller 13. For example, first target range A1 and first similar ranges A11 may be displayed at the same time on the same screen. Also, for example, first target range A1 and first similar ranges A11 may be displayed in different formats. As used herein, the term “different formats” mean that, for example, a frame shape, a display color, and the like are different. With this configuration, it is possible to present, to the user, the similar ranges automatically extracted by extractor 16. It is sufficient that at least one or more first similar ranges A11 are displayed.

Also, a sound of first similar ranges A11 shown in FIG. 5C may be output (reproduced) from sound output device 40 under control of sound output controller 14. For example, the waveforms of first target range A1 and one or more first similar ranges A11 may be combined by processor 17, and a sound indicated by the combined waveform may be output from sound output device 40 under control of sound output controller 14. With this configuration, it is possible to cause the sound of the similar ranges automatically extracted by extractor 16 to be heard by the user. In this way, as a result of at least one of the displaying of the similar ranges or the outputting of the sound being executed, it is possible to cause the user to check the automatically extracted similar ranges.

As described above, extractor 16 is configured to, when first target range A1 is input from the user, automatically extract one or more first similar ranges A11 that are similar to first target range A1. First target range A1 and one or more first similar ranges A11 each have, for example, the same temporal width (width on the horizontal axis).

Referring again to FIG. 4, input receiver 15 determines whether second target range A2 (see, for example, FIG. 5D, which will be described later) of the waveform has been additionally acquired (S60). Second target range A2 is a target range to be extracted in the displayed waveform, and is different from first target range A1. After the image shown in FIG. 5C has been displayed, input receiver 15 may further determine whether an input of second target range A2 has been received from the user (for example, whether a user input to the touch panel, the button, or the like has been detected).

FIG. 5D is a diagram showing second target range A2 input for the sound data of picked up sound.

As shown in FIG. 5D, input receiver 15 receives, for example, an input of second target range A2. Second target range A2 is, for example, a range that contains any one of first portions W3a, and does not overlap first target range A1 and first similar ranges A11. In FIG. 5D, second target range A2 is indicated by a dash-double dotted line.

The image shown in FIG. 5D may be displayed on display device 30 under control of controller 13. For example, only second target range A2 may be displayed, or first target range A1, first similar ranges A11, and second target range A2 may be displayed at the same time on the same screen. Also, a sound of second target range A2 shown in FIG. 5D may be output from sound output device 40 under control of sound output controller 14.

When input receiver 15 receives an input of second target range A2 as shown in FIG. 5D, input receiver 15 determines Yes in step S60.

If it is determined that an input of second target range A2 has been received by input receiver 15 (Yes in S60), extractor 16 further extracts, based on acquired second target range A2, one or more second similar ranges A22 (see, for example, FIG. 5D, which will be described later) that are similar to second target range A2 from the waveform shown in FIG. 5A (S70). A description of processing of extracting one or more second similar ranges A22 is omitted here because the processing is the same as the processing of extracting one or more first similar ranges A11. If it is determined that an input of second target range A2 has not been received by input receiver 15 (No in S60), extractor 16 proceeds the processing to step S80.

FIG. 5E is a diagram showing one or more second similar ranges A22 automatically extracted for the waveform of second target range A2. In FIG. 5E, second similar ranges A22 are indicated by a solid line.

FIG. 5E shows an example in which three second similar ranges A22 have been automatically extracted for second target range A2. The image shown in FIG. 5E may be displayed on display device 30 under control of controller 13. For example, first target range A1, first similar ranges A11, second target range A2, and second similar ranges A22 may be displayed at the same time on the same screen. Also, for example, first target range A1, first similar ranges A11, second target range A2, and second similar ranges A22 may be displayed in different formats. With this configuration, it is possible to present, to the user, the similar ranges automatically extracted by extractor 16. Here, it is sufficient that at least one or more second similar ranges A22 are displayed.

Also, a sound of second similar ranges A22 shown in FIG. 5E may be output from sound output device 40 under control of sound output controller 14. For example, the waveforms of first target range A1, second target range A2, one or more first similar ranges A11, and one or more second similar ranges A22 may be combined by processor 17, and a sound indicated by the combined waveform may be output from sound output device 40 under control of sound output controller 14. With this configuration, it is possible to cause the sound of the similar ranges automatically extracted by extractor 16 to be heard by the user. In this way, as a result of at least one of the displaying of the similar ranges or the outputting of the sound being executed, it is possible to cause the user to check the automatically extracted similar ranges.

As described above, extractor 16 is configured to, when second target range A2 is input from the user, automatically extract one or more second similar ranges A22 that are similar to second target range A2. Second target range A2 and one or more second similar ranges A22 each have, for example, the same temporal width (width on the horizontal axis).

Referring again to FIG. 4, processor 17 combines the extracted similar ranges, and sound output controller 14 causes a sound indicated by the combined similar range to be reproduced (S80). For example, after step S70, processor 17 extracts, from the sound data shown in FIG. 5A, the waveform of each of first target range A1, one or more first similar ranges A11, second target range A2, and one or more second similar ranges A22, and combines the extracted waveforms into one waveform. Alternatively, for example, after step S70, processor 17 may extract, from the sound data shown in FIG. 5A, the waveform of each of first target range A1 and one or more first similar ranges A11, combines the extracted waveforms into one waveform, and then further extract, from the sound data shown in FIG. 5A, the waveform of each of second target range A2 and one or more second similar ranges A22, and combine the extracted waveforms into one waveform.

Sound output controller 14 causes sound output device 40 to output a sound indicated by the sound data (training data) combined by processor 17. At this time, display controller 13 may cause display device 30 to display the sound data combined by processor 17.

Next, after step S80 or if it is determined by determiner 12 that the sound data does not contain a non-steady sound (No in S20), processor 17 registers the sound data (S90). That is, processor 17 stores the combined sound data in storage 18 as machine learning model training data.

The registering of the sound data may be performed in response to, after either the sound data combined by processor 17 has been displayed or the sound of the sound data combined by processor 17 has been output, a user input to permit the registering of the sound data being acquired by input receiver 15. With this configuration, the sound permitted by the user is registered, and thus the accuracy of analysis or the like using the non-steady sound is likely to be improved.

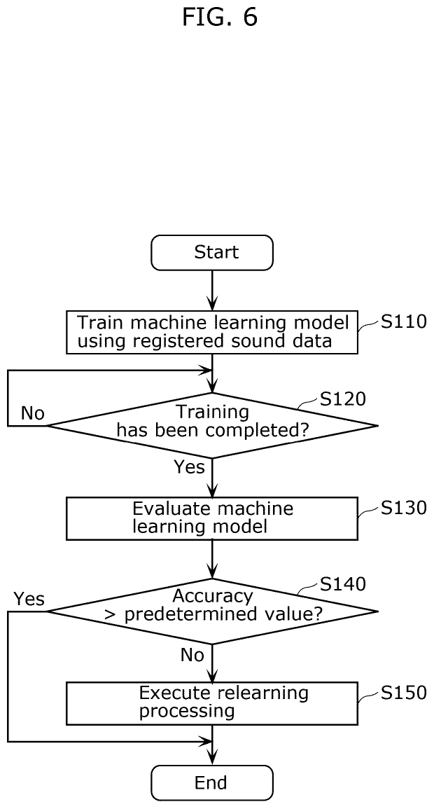

Next, an operation of using the registered sound data (training data) will be described with reference to FIG. 6. FIG. 6 is a flowchart illustrating a learning operation (an information processing method) performed by information processing system 1 according to the present embodiment.

As shown in FIG. 6, information processing device 10 causes the machine learning model to be trained using the registered sound data (S110). In other words, machine learning device 50 trains the machine learning model using the sound data registered by information processing device 10. Information processing device 10 outputs the sound data stored in storage 18 to machine learning device 50. Machine learning device 50 acquires the sound data from information processing device 10, and updates the network parameters of the machine learning model using the acquired sound data. In the case where a number of sound data greater than or equal to a predetermined number are stored in storage 18, information processing device 10 may output the number of sound data greater than or equal to the predetermined number to machine learning device 50.

Next, information processing device 10 determines whether the training has been completed (S120). For example, information processing device 10 determines whether the learning processing performed by machine learning device 50 has been completed.

Next, if it is determined that the training has been completed (Yes in S120), information processing device 10 evaluates the generated machine learning model (S130). If it is determined that the training has not been completed (No in S120), information processing device 10 stands by until the training is completed.

In step S130, evaluator 19 of information processing device 10 evaluates the machine learning model using evaluation sound data (evaluation data). The evaluation data may contain, for example, the sound data acquired in step S10 shown in FIG. 4. The evaluation data is stored in, for example, storage 18.

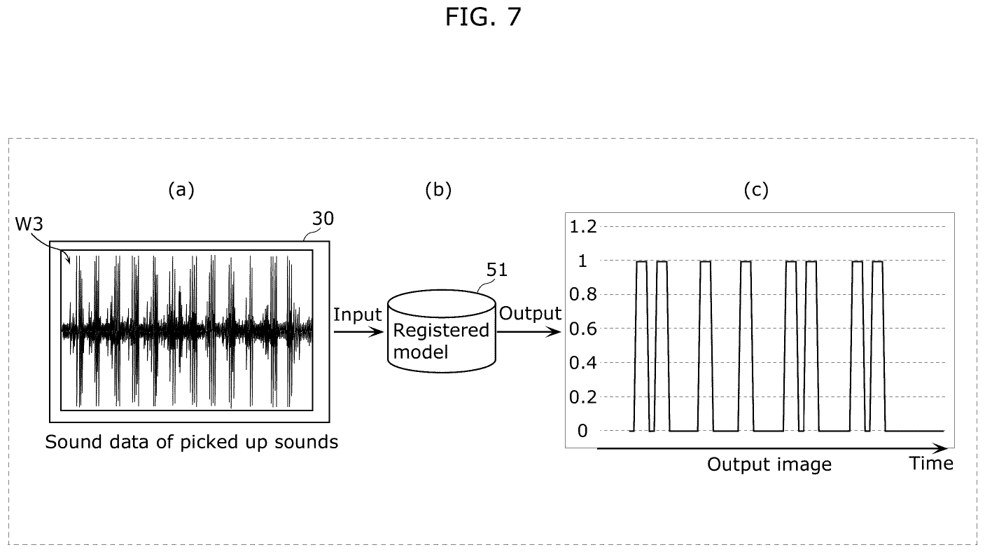

FIG. 7 is a diagram illustrating a method for evaluating the generated machine learning model according to the present embodiment. In FIG. 7, (a) indicates evaluation sound data W3 that is input into the machine learning model and contains, for example, the non-steady sound acquired in step S10 shown in FIG. 4. That is, sound data (raw data) that is the original sound data used to train the machine learning model is used as the evaluation data. As the evaluation data, pre-set sound data dedicated for evaluation may be used.

In FIG. 7, (b) indicates the registered model (trained machine learning model) stored in storage 51 of machine learning device 50. In FIG. 7, (c) indicates an output image output from the machine learning model. In the graph shown in (c) in FIG. 7, the horizontal axis indicates time, and the vertical axis indicates High (for example, “1” on the vertical axis) and Low (for example, “0” on the vertical axis). As the output from the machine learning model, High (for example, “1” on the vertical axis) is output when the target sound is emitted in the input sound data, and, otherwise, Low (for example, “0” on the vertical axis) is output. As described above, the machine learning model is a mathematical model that receives, as an input, a non-steady sound that contains first portions W3a and second portions W3b and outputs High for portions corresponding to when the target sound is emitted from the production device. The output image shown in (c) in FIG. 7 is an example in which the input sound data contains eight portions corresponding to when the target sound was emitted.

Evaluator 19 evaluates the machine learning model based on at least one of the number of times the target sound was emitted or temporal positions at which the target sound was emitted in the input sound data and at least one of the number of times High (for example, “1” on the vertical axis) was output or temporal positions at which High (for example, “1” on the vertical axis) was output in the output of the machine learning model. For example, for each of the plurality of temporal positions at which the target sound was emitted in the input sound data, evaluator 19 may give the highest evaluation level when, for example, the output of the machine learning model is High (specifically, when the number of times the target sound was emitted matches each of the temporal positions), and lower the evaluation level when the output of the machine learning model corresponding to a portion of the plurality of target sounds contained in the input sound data is Low, or the output of the machine learning model corresponding to a sound (for example, the sound of second portion W3b) other than the target sounds contained in the input sound data is High. For example, evaluator 19 outputs accuracy as a result of evaluation. The accuracy can be expressed as, for example, a numerical value ranging from 0 to 100. The result of evaluation may be, for example, the rate of accuracy or the rate of inaccuracy.

Referring again to FIG. 6, next, evaluator 19 determines whether the accuracy obtained as the result of evaluation is greater than a predetermined value (S140). The predetermined value is a threshold value for determining whether the machine learning model needs additional training, and is set in advance and stored in storage 18.

If it is determined that the accuracy is greater than the predetermined value (Yes in S140), evaluator 19 ends the learning processing. If it is determined that the accuracy is less than or equal to the predetermined value (No in S140), evaluator 19 executes relearning processing (S150). The relearning processing is processing of, for example, additionally generating machine learning model training data and re-updating the network parameters of the machine learning model. The machine learning model generated in the manner described above is used to grasp the operating status of the production device. For example, by counting the number of times High was output as the output of the machine learning model, it is possible to grasp the number of times the production device operated or the like.

### Variation 1 of Embodiment

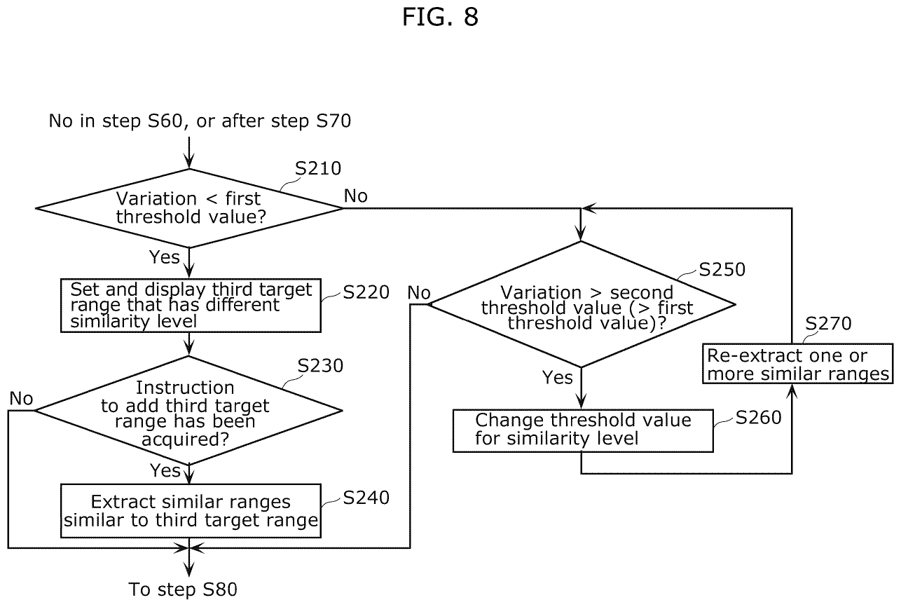

Hereinafter, an information processing method according to the present variation will be described with reference to FIG. 8. In the following, differences from the embodiment will be mainly described, and a description of elements that are the same as or similar to those of the embodiment will be omitted or simplified. An information processing system according to the present variation may have the same configuration as that of information processing system 1 according to the embodiment. Accordingly, a description of the configuration of the information processing system of the present variation will be omitted. Also, the following description will be given using the same reference numerals as those used to describe information processing system 1 according to the embodiment.

FIG. 8 is a flowchart illustrating a sound registration operation (an information processing method) performed by information processing system 1 according to the present variation. The information processing method according to the present variation is different from the information processing method according to the embodiment in that an operation of steps S210 to S260 is further executed after No is determined in step S60 shown in FIG. 6 or between steps S70 and S80. In the following, for the sake of convenience, only the operation performed after No is determined in step S60 will be described, but the same applies to the case where the operation is performed after step S70.

As shown in FIG. 8, processor 17 determines whether a variation in one or more first similar ranges A11 is less than a first threshold value (S210). Processor 17 calculates the variation based on the similarity level between first target range A1 and each of one or more first similar ranges A11. Processor 17 calculates, as the variation, for example, a standard deviation of the similarity level between first target range A1 and each of one or more first similar ranges A11, but the variation is not limited thereto.

When Yes is determined in step S120, it means that, for example, the variation in one or more first similar ranges A11 based on the similarity level (first similarity level) between the waveform of first target range A1 and the waveform of each of one or more first similar ranges A11 is smaller than the first threshold value.

Next, if it is determined by processor 17 that the variation is less than the first threshold value (Yes in S210), extractor 16 newly sets a third target range that contains a waveform whose similarity level with respect to the waveform of first target range A1 is different from the similarity level of one or more first similar ranges A11 extracted in step S50, and display controller 13 causes display device 30 to display the extracted third target range (S220). Extractor 16 automatically extracts the third target range. It can also be said that extractor 16 specifies the third target range whose similarity level with respect to the waveform of first target range A1 is different from the first similarity level. In the case where the third threshold value for determining as being similar is 80, and the first similarity level is 95, for example, extractor 16 may specify a range whose similarity level is 80 or more and 90 or less as the third target range. In the case where the first similarity level is 85, for example, extractor 16 may specify a range whose similarity level is 90 or more and 100 or less as the third target range. As described above, extractor 16 specifies, as the third target range, a range whose similarity level is different from the first similarity level from among the ranges that satisfy the threshold value. The first similarity level used herein is an average value of the similarity levels of one or more first similar ranges A11, but may be a median value, a mode value, a representative value, a minimum value, a maximum value, or the like.

Next, input receiver 15 determines whether an instruction to add the third target range displayed in step S220 has been acquired (S230). If it is determined that an instruction to add the third target range has been received from the user (for example, if it is determined that a user input to the touch panel, the button, or the like has been detected), input receiver 15 determines Yes in step S230. The processing in step S230 may be omitted.

Next, if it is determined that an instruction to add the third target range has been acquired by input receiver 15 (Yes in S230), extractor 16 extracts one or more similar ranges (one example of one or more second similar ranges) that are similar to the third target range (S240). The method for extracting one or more similar ranges that are similar to the third target range may be the same as that used in step S50 shown in FIG. 4, and thus a description thereof is omitted here.

It is considered that the waveforms of the similar ranges extracted in step S240 have a lower similarity level with respect to the sound of interest (for example, the sound of the waveform of first target range A1) as compared with, for example, the waveforms of the similar ranges extracted in step S50. In step S240, one or more ranges that contain a waveform slightly distorted from that of the sound of interest may be extracted as the one or more similar ranges.

Also, if it is determined that the variation is greater than or equal to the first threshold value (No in S210), processor 17 further determines whether the variation is greater than a second threshold value that is greater than the first threshold value (S250). If it is determined that the variation is greater than the second threshold value (Yes in S250), processor 17 changes the similarity threshold value (third threshold value) for determining as being similar (S260). If Yes is determined in step S250, processor 17 changes the third threshold value to a fourth threshold value that is greater than the third threshold value.

Next, extractor 16 re-extracts one or more first similar ranges A11 using the fourth threshold value changed by processor 17 (S270). Extractor 16 removes, for example, from one or more first similar ranges A11 extracted in step S50, first similar range A11 that does not satisfy the fourth threshold value changed by processor 17. Then, extractor 16 proceeds the processing to step S250.

If it is determined that an instruction to add the third target range has not been acquired by input receiver 15 (No in S230), or if it is determined by processor 17 that the variation is less than the second threshold value (specifically, greater than or equal to the first threshold value and less than the second threshold value) (No in S250), information processing device 10 proceeds the processing to step S80.

With this configuration, when the variation in the similarity level is small, one or more similar ranges are re-extracted to increase the variation in the similarity level. By training the machine learning model using the sound data that includes similar ranges extracted such that the similarity level varies to some extent as described above, the machine learning model with even greater versatility can be generated. Also, when the variation in the similarity level is large, one or more similar ranges are selected to reduce the variation in the similarity level. Accordingly, for example, a similar range that contains a sound different from the sound of interest such as noise can be removed. By training the machine learning model using the sound data that includes similar ranges extracted to reduce the similarity level as described above, the machine learning model with even greater accuracy can be generated. Also, as a result of the processing in step S230 being omitted, the variation in the similar ranges can be automatically adjusted, and thus information processing device 10 can effectively assist in extraction of the target sound from the non-steady sound.

The first threshold value and the second threshold value may be the same value.

### Variation 2 of Embodiment

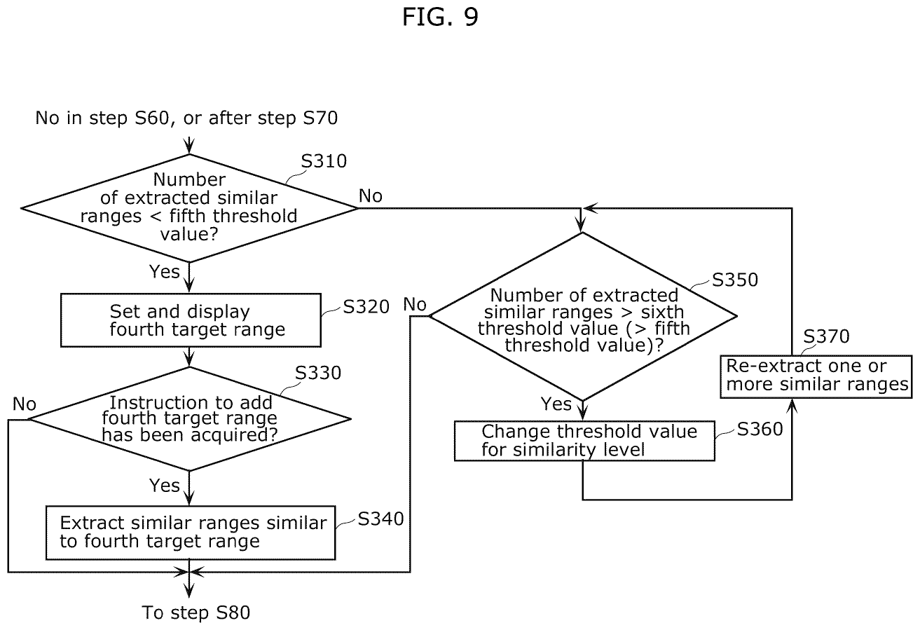

Hereinafter, an information processing method according to the present variation will be described with reference to FIG. 9. In the following, differences from the embodiment will be mainly described, and a description of elements that are the same as or similar to those of the embodiment will be omitted or simplified. An information processing system according to the present variation may have the same configuration as that of information processing system 1 according to the embodiment. Accordingly, a description of the configuration of the information processing system of the present variation will be omitted. Also, the following description will be given using the same reference numerals as those used to describe information processing system 1 according to the embodiment.

FIG. 9 is a flowchart illustrating a sound registration operation (an information processing method) performed by information processing system 1 according to the present variation. The information processing method according to the present variation is different from the information processing method according to the embodiment in that an operation of steps S310 to S360 is further executed after No is determined in step S60 shown in FIG. 6 or between steps S70 and S80. In the following, for the sake of convenience, only the operation performed when No is determined in step S60 will be described, but the same applies to when the operation is performed after step S70.

As shown in FIG. 9, processor 17 determines whether the number of one or more first similar ranges A11 extracted is less than a fifth threshold value (S310).

Next, if it is determined by processor 17 that the number of one or more first similar ranges A11 extracted is less than the fifth threshold value (Yes in S310), extractor 16 further sets a fourth target range, and display controller 13 causes display device 30 to display the extracted fourth target range (S320). The fourth target range is a range that does not overlap first target range A1 and one or more first similar ranges A11, and may be automatically extracted by extractor 16 based on the similarity level.

Next, input receiver 15 determines whether an instruction to add the fourth target range displayed in step S320 has been acquired from the user (S330). If it is determined that an input of an instruction to add the fourth target range has been received (for example, if it is determined that a user input to the touch panel, the button, or the like has been detected), input receiver 15 determines Yes in step S330. The processing performed in step S330 may be omitted.

Next, if it is determined that an instruction to add the fourth target range has been acquired by input receiver 15 (Yes in S330), extractor 16 extracts one or more similar ranges (one example of one or more second similar ranges) that are similar to the fourth target range (S340). The method for extracting one or more similar ranges that are similar to the fourth target range may be the same as that used in step S50 shown in FIG. 4, and thus a description thereof is omitted here.

Also, if it is determined by processor 17 that the number of first similar ranges extracted is greater than or equal to the fifth threshold value (No in S310), processor 17 further determines whether the number of first similar ranges extracted is greater than a sixth threshold value that is greater than the fifth threshold (S350). If it is determined by processor 17 that the number of first similar ranges extracted is greater than the sixth threshold value (Yes in S350), processor 17 changes the similarity threshold value (third threshold value) for determining as being similar (S360). If Yes is determined in step S350, processor 17 changes the third threshold value to a fourth threshold value that is greater than the third threshold value.

Next, extractor 16 re-extracts one or more first similar ranges A11 using the fourth threshold value changed by processor 17 (S370). Extractor 16 removes, for example, from one or more first similar ranges A11 extracted in step S50, first similar range A11 that does not satisfy the fourth threshold value changed by processor 17. Then, extractor 16 proceeds the processing to step S350.

Also, if it is determined that an instruction to add the fourth target range has not been acquired by input receiver 15 (No in S330), or if it is determined by processor 17 that the number of first similar ranges A11 extracted is less than the sixth threshold value (specifically, greater than or equal to the fifth threshold value and less than the sixth threshold value) (No in S350), information processing device 10 proceeds the processing to step S80.

With this configuration, when the number of extracted similar ranges is small, a target range for increasing the number of extracted similar ranges is additionally set. When the number of extracted similar ranges is large, the threshold value for similarity level (third threshold value) is changed to reduce the number of extracted similar ranges, and thus the number of similar ranges can be set to a number within a predetermined range. By training the machine learning model using the sound data that includes a number of similar ranges within the predetermined range, it is possible to generate the machine learning model with even greater accuracy while suppressing an increase in the amount of processing required by machine learning device 50. Also, as a result of the processing in step S330 being omitted, the number of similar ranges extracted can be automatically adjusted, and it is therefore possible to effectively support in extraction of the target sound from the non-steady sound.

The fifth threshold value and the sixth threshold value may be the same value.

### Variation 3 of Embodiment

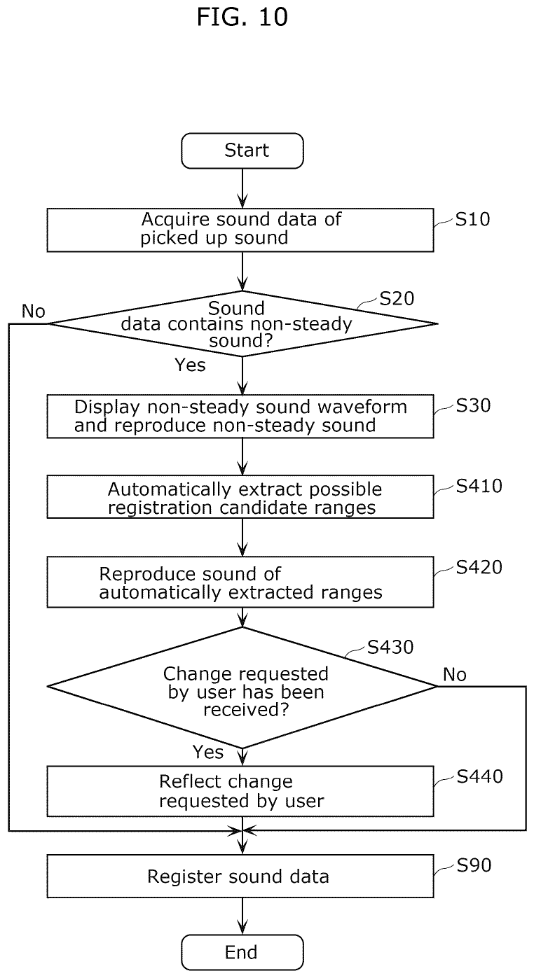

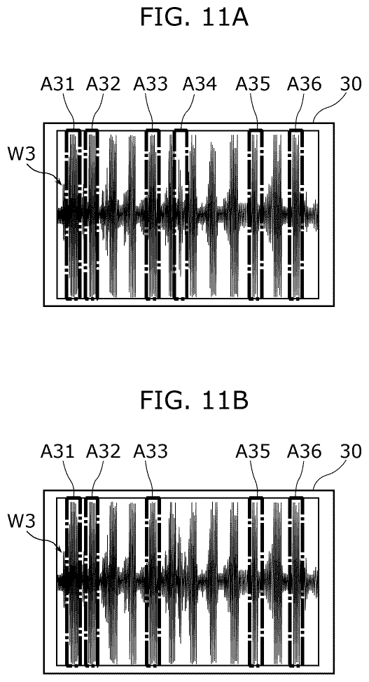

Hereinafter, an information processing method according to the present variation will be described with reference to FIGS. 10 to 11B. In the following, differences from the embodiment will be mainly described, and a description of elements that are the same as or similar to those of the embodiment will be omitted or simplified. An information processing system according to the present variation may have the same configuration as that of information processing system 1 according to the embodiment. Accordingly, a description of the configuration of the information processing system of the present variation will be omitted. Also, the following description will be given using the same reference numerals as those used to describe information processing system 1 according to the embodiment.

FIG. 10 is a flowchart illustrating a sound registration operation (an information processing method) performed by information processing system 1 according to the present variation. The information processing method according to the present variation is different from the information processing method according to the embodiment in that an operation of steps S410 to S440 is executed instead of the operation of steps S40 to S80 shown in FIG. 4.

As shown in FIG. 10, after the waveform has been displayed and the sound has been reproduced (S30), extractor 16 automatically extracts one or more possible registration candidate ranges from sound data W3 (S410). That is, extractor 16 automatically extracts one or more possible registration candidate ranges from sound data W3, without acquiring the first target range after step S30.

Any existing technique can be used to extract one or more possible registration candidate ranges. Extractor 16 may extract, from sound data W3, one or more ranges that include a waveform whose shape is similar to that of the target waveform registered in advance as the possible registration candidate ranges. Also, extractor 16 may extract, from sound data W3, one or more ranges that include a waveform whose frequency region is similar to (for example, at least partially overlaps) that of the target waveform registered in advance as the possible registration candidate ranges based on the graph showing the frequency spectrogram or the like. Also, extractor 16 may extract, from sound data W3, one or more ranges with a similar feature quantity based on the target waveform registered in advance as the possible registration candidate ranges. As described above, extractor 16 may automatically extract one or more possible registration candidate ranges using the similarity level with respect to the target waveform registered in advance. The method used by extractor 16 to automatically extract one or more possible registration candidate ranges is not limited thereto, and any existing technique can be used.

FIG. 11A is a diagram showing possible registration candidate ranges A31 to A36 automatically extracted for the sound data of picked up sound.

FIG. 11A shows an example in which possible registration candidate ranges A31 to A36 have been extracted from sound data W3 through automatic extraction. There is no particular limitation on the number of automatically extracted possible registration candidate ranges as long as the number of automatically extracted possible registration candidate ranges is one or more.

Referring again to FIG. 10, next, sound output controller 14 controls sound output device 40 to reproduce (output) a sound of automatically extracted possible registration candidate ranges A31 to A36 (S420). For example, processor 17 combines automatically extracted possible registration candidate ranges A31 to A36 together, and sound output controller 14 causes a sound indicated by the combined possible registration candidate ranges A31 to A36 to be reproduced. At this time, display controller 13 may cause display device 30 to display the sound data of possible registration candidate ranges A31 to A36 combined by processor 17.

Next, input receiver 15 determines whether a user's request to make a change to automatically extracted possible registration candidate ranges A31 to A36 has been received (S430). If it is determined that an input of a user's request to make a change to possible registration candidate ranges A31 to A36 has been received (for example, if it is determined that a user input to the touch panel, the button, or the like has been detected), input receiver 15 determines Yes in step S430.

Next, if it is determined by input receiver 15 that a user's request to make a change to possible registration candidate ranges A31 to A36 has been received (Yes in S430), processor 17 reflects the change requested by the user (S440). The making of the change includes deleting a portion of extracted possible registration candidate ranges A31 to A36. For example, the user may check the automatically extracted possible registration candidate ranges for an error. If an effort is found, a possible registration candidate range that has the error can be deleted. The making of the change may include further adding a possible registration candidate range to automatically extracted possible registration candidate ranges A31 to A36 or changing the size (for example, the width in the horizontal direction) of the possible registration candidate ranges.

FIG. 11B is a diagram showing the possible registration candidate ranges that are left after one of the possible registration candidate ranges has been deleted by the user.

FIG. 11B shows an example in which possible registration candidate range A34 has been deleted by the user from among automatically extracted possible registration candidate ranges A31 to A36. In this case, in step S90, out of possible registration candidate ranges A31 to A36, possible registration candidate ranges A31 to A33 and possible registration candidate ranges A35 and A36 are stored in storage 18 as machine learning model training data.

When the accuracy of automatic extraction is greater than or equal to a predetermined value, the processing in steps S430 and S440 may be omitted.

As described above, by automatically detecting one or more possible registration candidate ranges for the non-steady sound, particularly in the case of long-duration sound data, the burden on the user to select the possible registration candidate ranges can be reduced.

### Other Embodiments

Up to here, the information processing system and the like according to one or more aspects of the present disclosure have been described above by way of the embodiment, but the present invention is not limited to the embodiment given above. Other embodiments obtained by making various modifications that can be conceived by a person having ordinary skill in the art to the above embodiment as well as embodiments constructed by combining structural elements of different embodiments without departing from the scope of the present invention may also be included within the scope of the one or more aspects of the present disclosure.

For example, in the embodiment and the like described above, a production device is used as an example of the target object that emits sounds. However, the target object may be an image forming device that has a copy function, a printer function, and the like, an air conditioning device, or the like. The target object may be, for example, a device that includes one or more driving mechanisms.

Also, in the embodiment and the like described above, an example was described in which the target object is a device that emits either a steady sound or a non-steady sound. However, the target object is not limited thereto. The target object may be a device that emits a mixed sound of a steady sound and a non-steady sound. The information processing method and the like according to the present disclosure is also effective for the device.

Also, in the embodiment and the like described above, the structural elements may be implemented using dedicated hardware or may be implemented by executing a software program suitable for the structural elements. The structural elements may be implemented by a program executor such as a CPU or a processor reading and executing a software program recorded in a recording medium such as a hard disk, a semiconductor memory, or the like.

Also, the order of steps performed in each of the flowcharts is merely an example to specifically describe the present disclosure. Accordingly, the steps of each of the flowcharts may be performed in an order other than those described above. Also, a portion of the steps may be performed simultaneously (in parallel) with the other steps, or a portion of the steps may not necessarily be performed.

Also, the functional blocks shown in the block diagram are merely examples. Accordingly, it is possible to implement a plurality of functional blocks as a single functional block, or divide a single functional block into a plurality of blocks. Alternatively, some functions may be transferred to other functional blocks. Also, the functions of a plurality of functional blocks that have similar functions may be processed by a single piece of hardware or software in parallel or by time division.

Also, the information processing device or the machine learning device according to the embodiment and the like described above may each be implemented as a single device, or may be implemented by a plurality of devices. In the case where the information processing device or the machine learning device is implemented by a plurality of devices, the structural elements of the information processing device or the machine learning device may be assigned to the plurality of devices in any way. In the case where the information processing device or the machine learning device is implemented by a plurality of devices, there is no particular limitation on the communication method for performing communication between the plurality of devices. Wireless communication or wired communication may be used. Also, the communication between devices may be performed using a combination of wireless communication and wired communication. Also, a portion or all of the functions of either one of the information processing device or the machine learning device may be included in the other one of the information processing device or the machine learning device. For example, the information processing device and the machine learning device may be implemented as a unitary device.

Also, the structural elements described in the embodiment and the like described above may be implemented as software, or typically implemented as large scale integration (LSI) that is an integrated circuit. They may be configured into individual single chips, or a portion or all of them may be configured into a single chip. Also, LSI is used here, but the LSI may be called IC, system LSI, super LSI, or ultra LSI according to the degree of integration. Also, the method for implementing an integrated circuit is not limited to LSI, and may be implanted using a dedicated circuit (a general-purpose circuit that executes a dedicated program) or a general-purpose processor. It is also possible to use a field programmable gate array (FPGA) that can be programmed after LSI production or a reconfigurable processor that enables reconfiguration of the connection and setting of circuit cells in the LSI. Furthermore, if an integrated circuit technique that can replace LSI emerges due to advances in semiconductor technology or other derivative technologies, of course, that technology may be used to integrate the structural elements.

The system LSI is a super multifunctional LSI manufactured by integrating a plurality of processors on a single chip, and is specifically a computer system that includes a microprocessor, a read only memory (ROM), a random access memory (RAM), and the like. A computer program is stored in the ROM. The functions of the system LSI are implemented as a result of the microprocessor operating in accordance with the computer program.

Also, one aspect of the present disclosure may be a computer program that causes a computer to execute characteristic steps of the information processing method shown in any one of FIGS. 4, 6, 8, 9, and 10.

Also, for example, the program may be a program for causing a computer to execute the information processing method. Also, one aspect of the present disclosure may be a computer-readable non-transitory recording medium in which the program is recorded. For example, the program may be recorded in a recording medium and then distributed. For example, by installing the distributed program in a device that includes a processor and causing the processor to execute the program, it is possible to cause the device to execute the processing operations described above.

### INDUSTRIAL APPLICABILITY

The present disclosure is useful in an information processing device and the like that processes sound data obtained by picking up a sound emitted from a target object.

1. An information processing method executed by a computer, the information processing method comprising:
acquiring sound data obtained by picking up a sound emitted from a target object;
when the sound data contains a non-steady sound, presenting a waveform of the non-steady sound;
acquiring an input of a first target range in the waveform of the non-steady sound presented, the first target range being a target range to be extracted; and
extracting, from the sound data, one or more first similar ranges that each contain a waveform similar to a waveform of the first target range acquired.

2. The information processing method according to claim 1, further comprising:
after the extracting of the one or more first similar ranges, acquiring an input of a second target range in the waveform of the non-steady sound presented, the second target range being another target range to be extracted; and
extracting, from the sound data, one or more second similar ranges that each contain a waveform similar to a waveform of the second target range acquired.

3. The information processing method according to claim 1, further comprising:
when a variation in the one or more first similar ranges based on a first similarity level between the waveform of the first target range and a waveform of each of the one or more first similar ranges is less than a first threshold value, specifying a second target range whose similarity level with respect to the waveform of the first target range is different from the first similarity level; and
extracting, from the sound data, one or more second similar ranges that each contain a waveform similar to a waveform of the second target range specified.

4. The information processing method according to claim 1,
wherein the one or more first similar ranges is a range which includes a waveform that has a similarity level greater than or equal to a third threshold value with respect to the waveform of the first target range, and
when a variation in the one or more first similar ranges based on a first similarity level between the waveform of the first target range and a waveform of each of the one or more first similar ranges is greater than a second threshold value, the third threshold value is changed to a fourth threshold value that is greater than the third threshold value, and the one or more first similar ranges are re-extracted based on the fourth threshold value changed from the third threshold value.

5. The information processing method according to claim 1, further comprising:
when a total number of the one or more first similar ranges extracted is less than a fifth threshold value, specifying a second target range that is different from the first target range and the one or more first similar ranges; and
extracting, from the sound data, one or more second similar ranges that each contain a waveform similar to a waveform of the second target range specified.

6. The information processing method according to claim 1,
wherein the one or more first similar ranges is a range which includes a waveform that has a similarity level greater than or equal to a third threshold value with respect to the waveform of the first target range, and
when a total number of the one or more first similar ranges extracted is greater than a sixth threshold value, the third threshold value is changed to a fourth threshold value that is greater than the third threshold value, and the one or more first similar ranges are re-extracted based on the fourth threshold value changed from the third threshold value.

7. The information processing method according to claim 2, further comprising:
presenting the one or more first similar ranges extracted, and
after the presenting of the one or more first similar ranges extracted, acquiring the input of the second target range.

8. The information processing method according to claim 2, further comprising:
presenting the one or more second similar ranges extracted.

9. The information processing method according to claim 1, further comprising:
displaying a waveform of the sound data and reproducing the sound data; and
after the displaying of the waveform of the sound data and the reproducing of the sound data, acquiring the input of the first target range.

10. The information processing method according to claim 1, further comprising:
combining together the waveform of the first target range and the waveform of each of the one or more first similar ranges; and
reproducing sound data that includes a waveform obtained as a result of the combining.

11. The information processing method according to claim 2, further comprising:
combining together the waveform of the first target range, the waveform of the second target range, the waveform of each of the one or more first similar ranges, and the waveform of each of the one or more second similar ranges; and
reproducing sound data that includes a waveform obtained as a result of the combining.

12. The information processing method according to claim 1,
wherein the target object is a production device, and
the sound emitted from the target object includes a sound picked up during operation of the production device.

13. An information processing device comprising:
a first acquirer that acquires sound data obtained by picking up a sound emitted from a target object;
a presentation controller that, when the sound data contains a non-steady sound, presents a waveform of the non-steady sound;
a second acquirer that acquires an input of a first target range in the waveform of the non-steady sound presented, the first target range being a target range to be extracted; and
an extractor that extracts, from the sound data, one or more first similar ranges that each contain a waveform similar to a waveform of the first target range acquired.

14. A non-transitory computer-readable recording medium having recorded thereon a program for causing a computer to execute the information processing method according to claim 1.
